(19) United States
(12) Patent Application Publication
(10) Pub. No.: US 2010/0091692 A1
(43) Pub. Date: Apr. 15, 2010

(54) Access Terminal, Control Method Thereof, Base Station and Control Method Thereof

(75) Inventor: Susumu Kashiwase, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto (JP)

(21) Appl. No.: 12/593,586

(22) PCT Filed: Mar. 28, 2008
(86) PCT No.: PCT/JP2008/056190

§ 371 Date: Dec. 7, 2009

(30) Foreign Application Priority Data
Mar. 29, 2007 (JP) 2007-089059

(51) Int. Cl. G08C 17/02

(52) U.S. Cl. 370/311

(57) ABSTRACT

An access terminal receives, from a base station 10, an access terminal identifier (MAC-ID) assigned thereto to identify a self-terminal and information (Semi Connected Permit MAC-ID List) to permit a shift into a semi connected state where an access terminal 17 saves power while holding the access terminal identifier. When the access terminal 17 determines to be shifted into the semi connected state, the access terminal 17 transmits a request (Semi Connected Start Request) to the base station 10 to be shifted into the semi connected state based on the received information to permit the shift into the semi connected state and the access terminal identifier assigned to the self-terminal.

### TECHNICAL FIELD

The present invention relates to an access terminal, a control method thereof, a base station and a control method thereof in a mobile wireless communication in association with a semi connected state adopted by CDMA2000 Evolution (Ultra Mobile Broadband: UMB).

### BACKGROUND ART

A semi connected operation is known as a function implemented on an upper layer of CDMA2000 series advanced by use of technologies such as an OFDMA (Orthogonal Frequency Division Multiple Access) and the likes.

In the semi connected operation, for the purpose of power saving, a medium access control identifier (MAC-ID) is assigned and a semi connected state in which a reverse link (RL) is not transmitting while an assigned part of a forward link (FL) continues receiving is provided. Since it is possible to shift from the semi connected state into a communication state (Open State) by providing the semi connected state, it achieves faster shift than shift from an idle state to the open state.

The semi connected state is adopted by CDMA2000 Air Interface Evolution (Loosely Backwards Compatible: LBC) (see Non-Patent Document 1) and effective when used at a reception of PTT (Push To Talk). For example, two or more terminals (Access Terminal: AT) are dealt as a group for PIT in a cellular system and in a standby state (idle state) or a reception state simultaneously.

That is, two or more terminals are grouped and other terminals than the one during transmission are set in the reception state, so as to be used for a purpose of dispatch operation group call or the likes. In this operation style, the terminals are only receiving most of the time. That is, minimization of transmission on the reverse link contributes to a reduction in power consumption.

When a terminal in a PTT group transmits, other terminals in the group perform reception. Since it is necessary to pass through an access state in order to shift from the standby state to a call state, it takes time. For that reason, it was subject to an adverse effect such as breaking up of a beginning part of the call.

The terminal continues to monitor the forward link and periodically transmits reports on the reception state to the base station at long intervals. The base station periodically monitors the reports from the terminal by use of a timer. When the base station receives no report and the timer is expired, the semi connected state is cleared.

In the semi connected state, the access terminal operates as follows:

(1) In a power saving state
(2) No transmission on the reverse link (transmission of a reverse control channel)

### (3) Holding MAC-ID

(4) Periodically monitoring assignment information of the reverse link or the forward link (F-SCCH: Forward Shared Control Channel)

The semi connected state is canceled when Access Attempt is performed for a transmission on the reverse link, that is, when the access terminal shifts into the open state.

A scheme to reduce power consumption of a mobile terminal is disclosed by Patent Document 1.

### Patent Document 1: Japanese Patent Application Laid-open No. 2003-517741 Non-Patent Document 1: 3GPP2 TSG-CC21-20061030-009R2-Qualcomm_Semi Connected_Mode.pdf

### SUMMARY OF INVENTION

### Technical Problem

However, since the terminal performs only reception in the semi connected state while having MAC-ID assigned thereto, which is a value of 5 to 8 bits assigned to each sector on an air interface, it may cause a lack of MAC-ID. That is, if the terminal moves out of service area with keeping MAC-ID assigned thereto, it is not possible to use the MAC-ID for a certain period. In a case where, in particular, the terminals move out of service area all at once because the terminals are on a train and the train goes into underground or the terminals are in a car and the car comes into a tunnel, it causes the lack of MAC-ID in a particular sector.

Therefore, the base station is implemented with a message to reject a request from the terminal. The request is rejected not only in a case with the lack of MAC-ID but also in cases such as where the base station does not support, a network is not corresponding, the terminal cannot be shifted into the semi connected state because too many communication channels (traffic channels) are assigned to access terminals in the service area, On the other hand, since being not informed of a reason for rejection from the base station, the terminal requests a shift into the semi connected state again in vain.

An object of the present invention is to provide an access terminal capable of requesting retransmission effectively, a control method thereof, a base station and a control method thereof.

### Solution to Problem

In order to achieve the above object, a control method of an access terminal of the present invention includes: receiving an access terminal identifier (MAC-ID) assigned for identifying the access terminal from a base station; receiving information to permit a shift into a semi connected state where the access terminal saves power from the base station while holding the access terminal identifier; and transmitting a request to be shifted into the semi connected state to the base station based on the received information to permit the shift into the semi connected state and the access terminal identifier assigned to the access terminal, when it is determined to shift the access terminal into the semi connected state.

It is preferred that the control method of the access terminal of one embodiment of the present invention is to control so as to transmit the request to shift the access terminal into the semi connected state when the access terminal identifier assigned to the access terminal is included in the received information to permit the shift into the semi connected state.

It is also preferred that the control method of the access terminal of another embodiment of the present invention is to control so as not to transmit the request to shift the access terminal into the semi connected state when the access terminal identifier assigned to the access terminal is not included in the received information to permit the shift into the semi connected state.

An access terminal of the present invention includes: a reception unit for receiving, from a base station, an access terminal identifier assigned to identify the access terminal and information to permit a shift into a semi connected state where the access terminal saves power while holding the access terminal identifier; and a transmission unit for transmitting a request to be shifted into the semi connected state based on the information to permit the shift into the semi connected state received by the reception unit and the access terminal identifier assigned to the self-terminal, when the access terminal determines to be shifted into the semi connected state.

It is preferred that the reception unit of the access terminal of one embodiment of the present invention has a function for receiving an access parameter message.

In addition, a control method of a base station of the present invention includes: assigning an access terminal identifier for identifying an access terminal that the base station controls to an access terminal of the base station; generating information to permit a shift into a semi connected state where the access terminal saves power, while the access terminal is holding the access terminal identifier; and transmitting the generated information to permit the shift into the semi connected state to the access terminal.

Moreover, a base station of the present invention includes: an assigning unit for assigning an access terminal identifier for identifying an access terminal that the base station controls to an access terminal of the base station; a generation unit for generating information to permit a shift into a semi connected state where the access terminal saves power, while the access terminal is holding the access terminal identifier; and a transmission unit for transmitting the information to permit the shift into the semi connected state generated by the generation unit to the access terminal.

### EFFECT OF THE INVENTION

According to the present invention, it is possible to identify an access terminal which can be shifted to a semi connected state. Moreover, since the transmission of a shift request (Semi Connected start) into the semi connected state by the access terminal is optimized and effective, it is possible to save a reverse transmission resource.

### BRIEF DESCRIPTION OF DRAWINGS

FIG. 1 is a block diagram illustrating a constitution of a base station according to an embodiment of the present invention;

FIG. 2 is a block diagram illustrating a constitution of an access terminal according to an embodiment of the present invention;

FIG. 3 is a flow chart illustrating a flow of a control processing of the base station;

FIG. 4 is a flow chart illustrating a flow of a control processing of the access terminal;

FIG. 5 is a sequence diagram illustrating exchange of massages between the base station and the access terminal;

FIG. 6 is an explanatory diagram illustrating an example of the Semi Connected Permit MAC-ID List in FIG. 5; and

FIG. 7 is a flow chart illustrating an example of a flow of an operation by the access terminal.

### REFERENCE SIGNS LIST

10 base station
11a, 18a antenna
11, 18 RF transceiver unit
12 transmission circuit unit
13 reception circuit unit
14, 24 memory unit
15 bus
16, 23 control unit
17 access terminal
19 transmission system RF circuit unit
20 reception system RF circuit unit
21 transmission modulator unit
22 reception modulator unit
25 baseband signal processing unit
26 protocol control unit
27 man machine interface control unit
28 display unit
29 input apparatus
30a, 30b speaker
31 microphone

### DESCRIPTION OF EMBODIMENTS

Preferred embodiments of the present invention will be described with reference to the accompanying drawings.

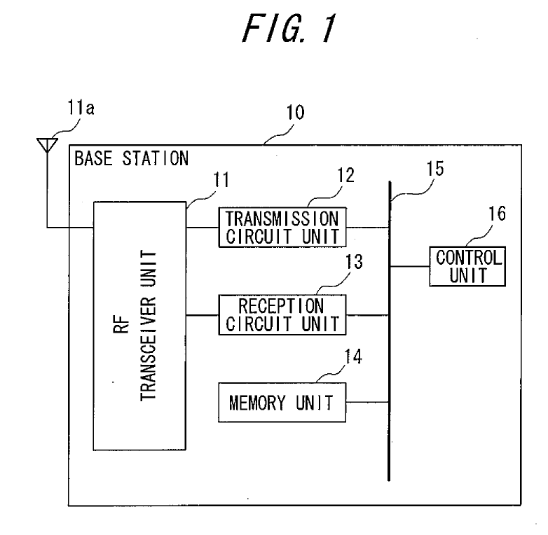

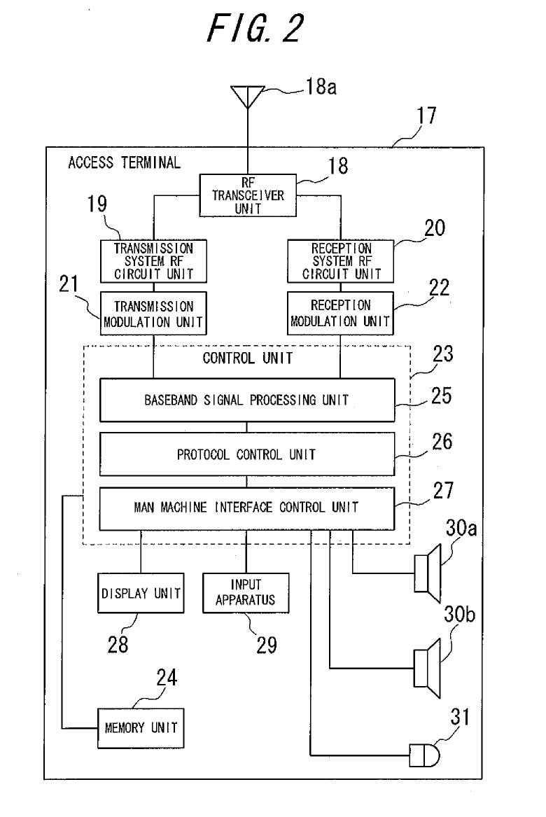

FIG. 1 is a block diagram illustrating a constitution of a base station according to an embodiment of the present invention. As shown in FIG. 1, a base station 10 is provided with an RF transceiver unit 11 for transmitting and receiving a signal via an antenna 11a with an access terminal 17 (see FIG. 2), which is a communication terminal apparatus such as a cellular phone and will be describe below, a transmission circuit unit 12 and a reception circuit unit 13 connected to the RF transceiver unit 11, a memory unit 14 for storing data to be processed in the base station 10, and a control unit 16 connected to the transmission circuit unit 12, the reception circuit unit 13 and the memory unit 14 via a bus 15 and for controlling operations in the base station 10.

It is to be noted that the “base station” described in the present embodiment includes a “sector” as well.

In cooperation with each unit described above as necessary, the control unit 16 functions as a transmission unit for determining a state of the base station 10 based on a capacity of the base station or of the sector and transmitting information (Semi Connected Permit MAC-ID List) to permit a shift into a semi connected state to the access terminal 17.

In cooperation with each unit described above as necessary, the control unit 16 also functions as a reception unit for receiving a shift request into the semi connected state (Semi Connected start Request) from the access terminal 17, which saves power (power saving state) in the semi connected state, with holding an access terminal identifier (MAC-ID) assigned thereto by the base station 10 to identify the access terminal 17, and as a transmission unit for determining a state of the base station 10 in response to the shift request and, when the base station 10 cannot permit the shift as a result of the determination of the state of the base station 10, transmitting a response to the shift request (Semi Connected start Reject) with a rejection reason to the access terminal 17.

The base station 10 determines the state thereof based on whether the base station 10 supports a function to shift the access terminal 17 into the semi connected state, and determines the state of the base station 10 or a state of the sector based on the capacity thereof. In a case where the base station 10 or the sector does not support the function to shift the access terminal 17 into the semi connected state, the transmission unit transmits a response with a reason that the base station 10 or the sector does not support to the access terminal 17 to the shift request. In a case where the capacity of the base station 10 or the sector exceeds a predetermined value, the transmission unit transmits the response with a reason that the capacity of the base station or the sector exceeds the predetermined value to the access terminal 17 to the shift request.

The capacity of the base station 10 or of the sector is based on the number of access terminal identifiers remained or assigned by the base station 10 or the sector to identify the access terminal 17, and also based on the number of communication channels remained or assigned to the access terminal 17 by the base station 10 or the sector.

FIG. 2 is a block diagram illustrating a constitution of the access terminal according to an embodiment of the present invention. As shown in FIG. 2, the access terminal 17 is provided with an RF transceiver unit 18 for transmitting and receiving a signal with the base station 10 (see FIG. 1) via an antenna 18a, a transmission system RF circuit unit 19 and a reception system RF circuit unit 20 connected to the RF transceiver unit 18, a transmission modulator unit 21 connected to the, transmission system RF circuit unit 19, a reception demodulator unit 22 connected to the reception system RF circuit unit 20, a control unit 23 to which the transmission modulator unit 21 and the reception demodulator unit 22 are connected, and a memory unit 24 connected to the control unit 23.

The control unit 23 is provided with a baseband signal processing unit 25 to which the transmission modulator unit 21 and the reception demodulator unit 22 are connected, a protocol control unit 26 connected to the baseband signal processing unit 25, and a man machine interface control unit 27 connected to the protocol control unit 26. Connected to the man machine interface control unit 27 are a display unit 28 such as an LCD (Liquid Crystal Display) and the likes, an input apparatus 29 such as a keyboard and the likes to input information, speakers 30a and 30b, and a microphone 31.

In cooperation with each unit described above as necessary, the control unit 23 functions as a reception unit for receiving the information (Semi Connected Permit MAC-ID List) to permit the shift into the semi connected state where the access terminal goes into the power saving state with holding the access terminal identifier (MAC-ID) from the base station.

Also, when determining to shift a self-terminal into the semi connected state, the control unit 23, functions as a transmission unit for transmitting a request (Semi Connected Start) to shift the self-terminal into the semi connected state to the base station based on the received information (Semi Connected Permit MAC-ID List) to permit the shift into the semi connected state and the access terminal identifier (MAC-ID) assigned to the self-terminal.

In cooperation with each unit stated above as necessary, the control unit 23 functions as the transmission unit for transmitting the shift request into the semi connected state where the access terminal 17 saves power to the base station 10 while holding the access terminal identifier assigned by the base station 10 to identify the access terminal 17, as the reception unit for receiving a response to the shift request from the base station 10, and as a control unit for controlling retransmission of the shift request, when the response received indicates that the shift into the semi connected state is not permitted, based on the reason for not permitting the shift accompanying the response.

In addition, the access terminal performs as follows in the semi connected state:

(1) In a power saving state
(2) No transmission on the reverse link (no transmission of a reverse control channel)

### (3) Holding MAC-ID

(4) Periodically monitoring assignment information of the reverse link or the forward link (F-SCCH: Forward Shared Control Channel)

The semi connected state is canceled when Access Attempt is performed for a transmission on the reverse link, that is, when the access terminal shifts into the open state.

When the reason for not permitting the shift accompanying the response indicates that the base station 10 or the sector does not support the function to shift the access terminal 17 into the semi connected state, the control unit does not retransmit the shift request but, if the access terminal 17 performs hand off to another base station or another sector, controls to newly transmit a shift request to the base station or the sector to which the access terminal 17 performs hand off. When the reason for not permitting the shift accompanying the response indicates that the capacity of the base station 10 or of the sector exceeds the predetermined value, the control unit controls to retransmit the shift request to the base station 10 after a predetermined period.

The capacity of the base station 10 or of the sector is based on the number of access terminal identifiers remained or assigned by the base station 10 or the sector to identify the access terminal 17, or the number of communication channels remained or assigned to the access terminal 17 by the base station 10 or the sector.

In order to address a lack of MAC-ID in a particular sector, the number of terminals (access terminals 17) which enter a semi connected mode is limited.

In order to limit the number of terminals which enter the semi connected mode, the MAC-ID of the terminal to be shifted into the semi connected state is limited.

First, an “Access Parameter” message is expanded. Thereby, a list of MAC-IDs to be shifted into the semi connected state is preliminary notified. The terminal enters an idle state by use of a content of the “Access Parameter” message. The MAC-ID is assigned to the terminal when the terminal enters the open state from the idle state. In a case where the MAC-ID of the self-station is listed in a Semi Connected Permit MAC-ID List, the terminal transmits a shift request (Semi Connected Start) message into the semi connected state while being in the open state.

That is, the base station is capable of limiting the number of terminals which enters the semi connected state by itself, and the terminal is capable of knowing preliminary whether to be rejected to enter the semi connected state by comparing the MAC-ID of the self-terminal to the semi connected permit MAC-ID list. Thus, the base station is capable of limiting the number of terminals which enter the semi connected state for the base station/a single sector.

Next comes descriptions of control methods of the base station 10 and the access terminal 17.

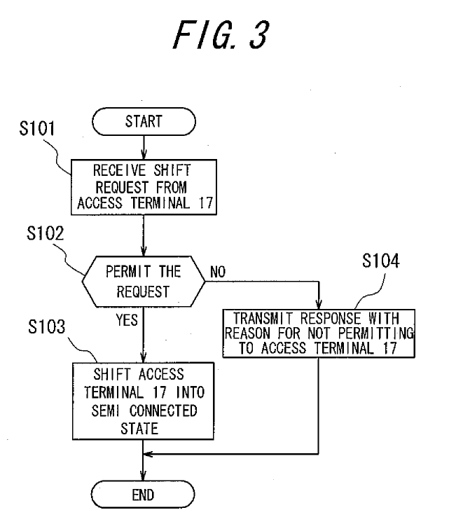

FIG. 3 is a flow chart illustrating a flow of a control processing of the base station. First, as shown in FIG. 3, the base station 10 receives a shift request into the semi connected state from the access terminal 17 which saves power in the semi connected state (S101). At this time, the access terminal 17 is still holding the MAC-1D which the base station 10 has assigned to identify the access terminal 17.

Then, the base station 10 determines the state of itself or a sector to determine whether to permit the shift request (step S102). The base station 10 or the sector determines the state thereof based on whether the base station 10 or the sector supports the function to shift the access terminal 17 into the semi connected state, and also based on a state of the capacity of the base station or the sector at the present time.

When it is possible to permit (YES) the shift request into the semi connected state as a result of the determination, the base station 10 shifts the access terminal 17 into the semi connected state (S103) and then ends the processing. On the other hand, when it is not possible to permit (NO) the shift request into the semi connected state, the base station 10 transmits a response with the reason for not permitting the shift request to the access terminal 17 (S104) and then ends the processing.

That is, in a case where the base station 10 or the sector does not support the function to shift the access terminal 17 into the semi connected state, the base station 10 transmits the response accompanied by the reason that the base station 10 or the sector does not support the function to the shift request. In addition, the base station 10 or the sector determines its state based on the capacity thereof and, when the capacity thereof exceeds the predetermined value, transmits the response accompanied by the reason that the capacity of the base station 10 or of the sector exceeds the predetermined value to the shift request.

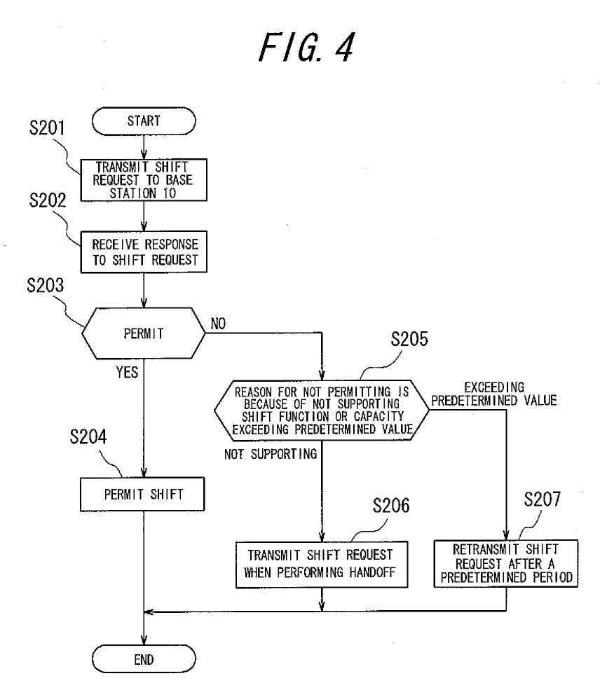

FIG. 4 is a flow chart illustrating a flow of a control processing of the access terminal. First, as shown in FIG. 4, the access terminal 17 transmits a shift request into the semi connected state where the access terminal 17 saves power to the base station 10 (S201). At this point, the access terminal 17 is still holding the MAC-1D which the base station has assigned to identify the access terminal 17.

Then, the access terminal 17 receives a response to the shift request from the base station 10 (S202). The access terminal 17 determines whether the response received indicates to permit the shift into the semi connected state (S203) and, when the response indicates it is permitted (YES), permits the shift into the semi connected state and shifts into the semi connected state (S204), and then ends the processing.

On the other hand, when the response indicates that it is not permitted (NO), the access terminal 17 retransmits the shift request based on the reason for not permitting accompanying the response. At this time, the access terminal 17 determines the reason for not permitting accompanying the response (S205). In a case where the reason indicates that the base station 10 or the sector does not support the function to shift the access terminal 17 into the semi connected state, the access terminal 17 does not retransmit the shift request but, if the access terminal 17 performs hand off after waiting for hand off to another base station or another sector, newly transmits a shift request to the base station or the sector to which the access terminal 17 performs hand off (S206). In a case where the reason for not permitting accompanying the response indicates that the capacity of the base station 10 or of the sector exceeds the predetermined value, the access terminal 17 retransmits the shift request after the predetermined period (S207).

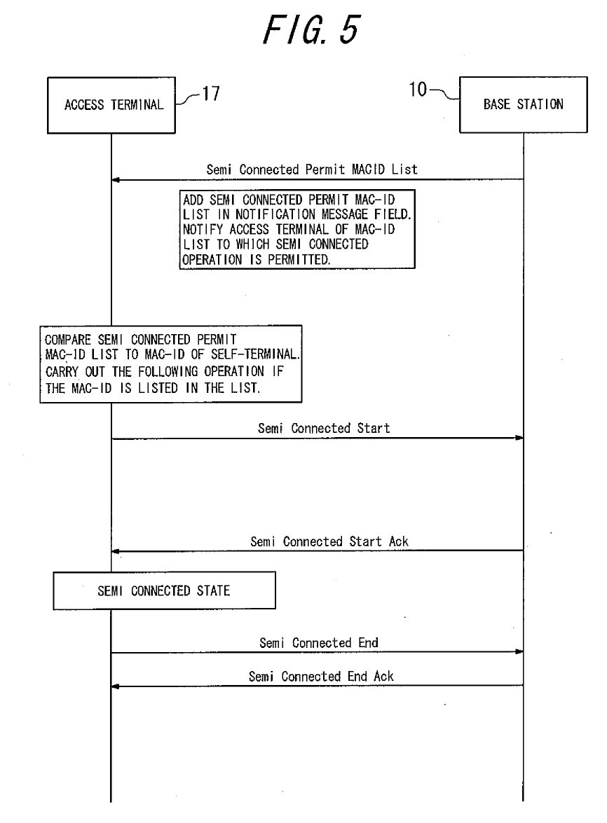

FIG. 5 is a sequence diagram illustrating exchange of massages between the base station and the access terminal. As shown in FIG. 5, the base station 10 and the terminal (access terminal 17) are in the open state and the base station 10 transmits the information (Semi Connected Permit MAC-ID List) to permit the shift into the semi connected state to the access terminal 17. More specifically, the base station 10 notifies the access terminal 17 of the Semi Connected Permit MAC-ID List in a field of a notification message.

When the access terminal 17 receives the Semi Connected Permit MAC-ID List and shifts into the semi connected state, the access terminal 17 compares the Semi Connected Permit MAC-ID List with the MAC-ID of the self-terminal (access terminal 17). In a case where the MAC-ID is included in the list, the access terminal 17 performs the following operations.

The access terminal 17 transmits a shift request (Semi Connected Start) into the semi connected state to the base station 10. When receiving the shift request, the base station 10 transmits an acknowledge response (Semi Connected Start Ack) to the access terminal 17. After receiving the acknowledge response, the access terminal 17 shifts into the semi connected state.

Subsequently, in order to end the semi connected state, the access terminal 17 transmits a semi connected state end signal (Semi Connected End) to the base station 10. When receiving the Semi Connected End, the base station 10 transmits the acknowledge response to the access terminal 17.

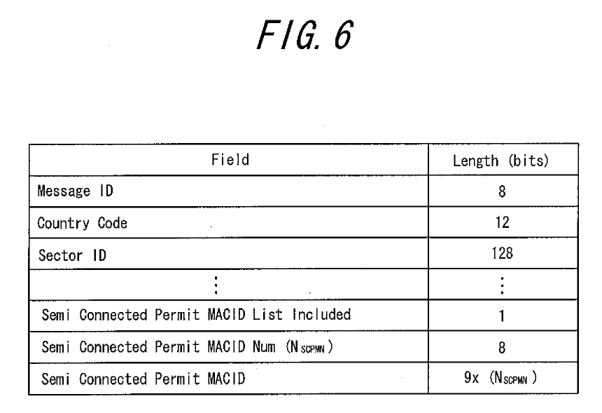

FIG. 6 is an explanatory diagram illustrating the Semi Connected Permit MAC-ID List in FIG. 5. In FIG. 6, the Semi Connected Permit MAC-ID List is transmitted by being inserted in a sector parameter message.

The Semi Connected Permit MACID List Included is 1 when Semi Connected Permit MACID List is included therein while it is 0 when Semi Connected Permit MACID List is not included therein. The Semi Connected Permit MACID Num;N_{scpmn} is the number of MAC-IDs included in Semi Connected Permit MACID List. The Semi Connected Permit MACID is a filed length of MAC-ID permitted to shift into semi connected state.

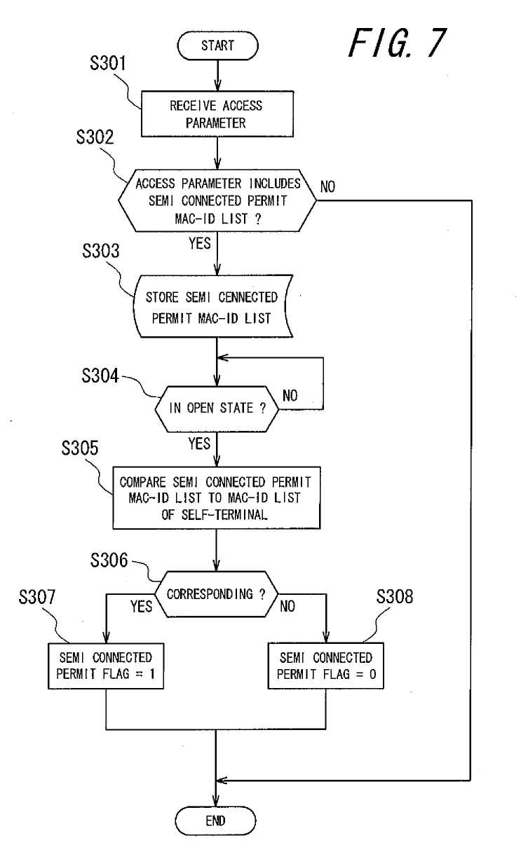

FIG. 7 is a flow chart illustrating an example of a flow of an operation by the access terminal. As shown in FIG. 7, when receiving an access parameter (S301), the access terminal 17 determines whether the Semi Connected Permit MAC-ID List is included in the access parameter received (S302). When the list is included (YES) as a result, the access terminal 17 stores the Semi Connected Permit MAC-ID List in the memory unit 24 (S303). On the contrary, when the list is not included (NO), the processing is ended. After storing the Semi Connected Permit MAC-ID List, the access terminal 17 determines whether it is in the open state (S304).

Until this time, the access terminal 17 has been in the idle state and enters the open state thereafter.

When it is in the open state (YES) as a result of the determination at the step S304, the access terminal 17 compares the Semi Connected Permit MAC-ID List to the MAC-ID of the self-terminal (S305). On the contrary, when it is not in the open state (NO), the access terminal 17 repeats the determination.

Next, the access terminal 17 determines whether there is a MAC-ID which corresponds to the MAC-ID of the self-terminal in the Semi Connected Permit MAC-ID List, as a result of the comparison (S306). When there is a corresponding MAC-ID (YES) as the result of the determination, a Semi Connected Permit flag is set to 1, (step S307), while the Semi Connected Permit flag is set to zero (step S308) when there is no corresponding MAC-ID (NO) and then the access terminal 17 ends the processing.

As described above, the access terminal 17 is provided with a reception unit (the RF transceiver unit 18, the reception system RF circuit unit 20 and the reception modulation unit 22) for receiving the MAC-ID assigned to identify the self-terminal and the information (Semi Connected Permit MAC-ID List) to permit the shift into the semi connected state where the access terminal 17 goes into the power saving state while holding the MAC-ID from the base station 10, and a transmission unit (RF transceiver unit 18, the transmission system RF circuit unit 19 and the transmission modulation unit 21), when the access terminal 17 determines to be shifted into the semi connected state, for transmitting a request to be shifted into the semi connected state (Semi Connected Start Request) to the base station 10 based on the Semi Connected Permit MAC-ID List received by the reception unit and the MAC-ID assigned. The reception unit has a function for receiving an access parameter message.

The access terminal 17 having the above constitution receives the MAC-ID assigned to identify the terminal 17 and the information (Semi Connected Permit MAC-ID List) to permit the shift into the semi connected state where the access terminal 17 saves power (power saving state) from the base station 10 while holding the MAC-ID. When the access terminal 17 determines to be shifted into the semi connected state, the access terminal 17 transmits the Semi Connected Start Request to the base station 10 based on the received Semi Connected Permit MAC-ID List and the MAC-ID assigned.

In a case where the MAC-ID assigned to the access terminal 17 is included in the received information to permit the shift into the semi connected state, the access terminal 17 controls the transmission unit to transmit the Semi Connected Start Request to be shifted into the semi connected state. On the contrary, in a case where the MAC-ID assigned to the access terminal 17 is not included, the access terminal 17 controls the transmission unit not to transmit the Semi Connected Start Request.

Meanwhile, the base station 10 is provided with an assigning unit (control unit 16) for assigning MAC-ID for identifying an access terminal that the base station 10 controls to the access terminal 17 of the self-station, a generation unit (control unit 16) for generating the information (Semi Connected Permit MAC-ID List) to permit the shift into the semi connected state where the access terminal 17 goes into the power saving state while the access terminal 17 is holding the MAC-ID, and a transmission unit (RF transceiver unit 11, transmission circuit unit 12) for transmitting the Semi Connected Permit MAC-ID List generated by the generation unit to the access terminal 17.

The base station 10 having the above constitution assigns MAC-ID for identifying an access terminal that the base station 10 controls to the access terminal 17 of the self-station and, based on a capacity state of the self-station, a predetermined MAC-ID and the likes, generates the information (Semi Connected Permit MAC-ID List) to permit the shift into the semi connected state where the access terminal 17 goes into the power saving state while the access terminal 17 is holding the MAC-ID, and transmits the generated Semi Connected Permit MAC-ID List to the access terminal 17.

That is, in order to limit the number of terminals for the base station/a single sector permitted to enter the semi connected state, the base station 10 preliminary notifies an access terminal of a list of MAC-IDs permitted to enter the semi connected state. Thus, only the terminals to which MAC-IDs permitted to enter the semi connected state are assigned, transmit Semi Connected Start Request to the base station 10.

It is possible to use both of or only one of a processing to notify (transmit) an access terminal of the information (Semi Connected Permit MAC-ID List) permitting the shift into the semi connected state and a processing to notify (transmit) the access terminal of the reason for rejecting the shift into the semi connected state in the present embodiment.

Although being described by use of the embodiment set forth above, the present invention is not limited thereto but includes varied forms thereof within the scope of the present invention.

This application claims priority to and the benefit of Japan Patent Application No. 2007-089059 (filed on Mar. 29, 2007), the entire contents of which are incorporated herein by reference.

1. A control method of an access terminal comprising:
receiving an access terminal identifier assigned for identifying the access terminal from a base station;
receiving information to permit a shift into a semi connected state where the access terminal saves power from the base station while holding the access terminal identifier; and
transmitting a request to be shifted into the semi connected state to the base station based on the received information to permit the shift into the semi connected state and the access terminal identifier assigned to the access terminal, when it is determined to shift the access terminal into the semi connected state.

2. The control method of the access terminal according to claim 1, further comprising controlling so as to transmit the request to be shifted into the semi connected state when the access terminal identifier assigned to the access terminal is included in the received information to permit the shift into the semi connected state.

3. The control method of the access terminal according to claim 1, further comprising controlling so as not to transmit the request to be shifted into the semi connected state when the access terminal identifier assigned to the access terminal is not included in the received information to permit the shift into the semi connected state.

4. An access terminal comprising:
a reception unit for receiving, from a base station, an access terminal identifier assigned to identify the access terminal and information to permit a shift into a semi connected state where the access terminal saves power while holding the access terminal identifier; and
a transmission unit for transmitting a request to be shifted into the semi connected state based on the information to permit the shift into the semi connected state received by the reception unit and the access terminal identifier assigned, when the access terminal determines to be shifted into the semi connected state.

5. The access terminal according to claim 4, wherein the reception unit has a function for receiving an access parameter message.

6. A control method of a base station comprising:
assigning an access terminal identifier for identifying an access terminal that the base station controls to an access terminal of the base station;
generating information to permit a shift into a semi connected state where the access terminal saves power, while the access terminal is holding the access terminal identifier; and
transmitting the generated information to permit the shift into the semi connected state to the access terminal.

7. A base station comprises:
an assigning unit for assigning an access terminal identifier for identifying an access terminal that the base station controls to an access terminal of the base station;
a generation unit for generating information to permit a shift into a semi connected state where the access terminal saves power, while the access terminal is holding the access terminal identifier; and
a transmission unit for transmitting the information to permit the shift into the semi connected state generated by the generation unit to the access terminal.
